(19) United States
(12) Patent Application Publication
(10) Pub. No.: US 2025/0052555 A1
(43) Pub. Date: Feb. 13, 2025

(54) Fish Tape Measurement Device

(71) Applicant: Bunthy Kong, Harrisburg, PA (US)

(72) Inventor: Bunthy Kong, Harrisburg, PA (US)

(21) Appl. No.: 18/645,943

(22) Filed: Apr. 25, 2024

Related U.S. Application Data
(60) Provisional application No. 63/518,931, filed on Aug. 11, 2023.

(51) Int. Cl. G01B 3/1084; B65H 75/40; H02G 1/08

(52) U.S. Cl. CPC G01B 3/1084; B65H 75/406; H02G 1/083; B65H 2701/376

(57) ABSTRACT

A fish tape measurement device is disclosed. The fish tape measurement device comprises a body component that encases a spool of wire. The wire on the spool is a narrow, flat wire which comprises a plurality of measuring units marked throughout. The wire on the spool can wind in and out from approximately 100 to 200 feet. Thus, the markings will provide electricians with an exact length measurement in order to prevent cable and wire waste when working on a jobsite.

### CROSS-REFERENCE TO RELATED APPLICATION

The present application claims priority to, and the benefit of, U.S. Provisional Application No. 63/518,931, which was filed on Aug. 11, 2023, and is incorporated herein by reference in its entirety.

### FIELD OF THE INVENTION

The present invention relates generally to the field of fish tape measurement devices. More specifically, the present invention relates to electrician fish tape with unit mark measurements along its length. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in fish tape measurement devices. Generally, applying cable and wire on an electrician job site can be a difficult and frustrating task. Some areas may require an estimation as to how much cable and wire is needed. If too much is cut, the excess cable or wire is essentially wasted. Thus, people may lack the means to make proper measurements while measuring out cable and wires.

The present invention, in general relates to devices used for pulling electrical wires through conduits and, more particularly, to devices that are commonly referred to as “fish tapes”. In the electrical arts, electricians often must pull wires through pipes. To assist, a tool is used that includes a spoolable but stout material (usually metal) that is reeled off of the tool and forced in through the conduit until it exits at an opposite end. The electrical wires are then attached to one end of spoolable material (usually by wrapping them with electrical tape) and the tool is then used to pull the spoolable material, along with the wires, through the conduit. Once the wires are fully pulled through the conduit, the electrical tape is removed and the wires are disconnected apart from the spoolable material. The casing of the tool itself is grabbed and is used to pull, even jerk, the wires through the conduit. Such kinds of tools are well known in the electrical wiring (commercial or residential) industry and are commonly referred to as “fish tape”. Electricians know that fish tape is used for pulling wire.

A vexing problem arises because electricians never really know how much wire is required for pulling through a conduit. Wire is expensive. When they have to buy wire for pulling (sometimes called “snaking”) through a conduit, they do not want to buy too much and have the excess go to waste. Even worse is to buy too little wire and go through all of the labor of pulling a heavy gauge wire through a long run of conduit only to run short and not have enough wire to complete the job. When the term “wire” is used it is intended to apply to any type of wire used in the electrical wiring arts. This includes single and multiple conductor wires of any gauge and having any type of insulation that is required for the task at hand.

There are no effective methods for an electrician to determine how much wire will be required. Although it is at times possible for short runs (i.e., lengths of conduit), electricians are usually unable to force a measuring tape through a conduit because measuring tapes are not sufficiently rigid enough to permit pushing them through long runs of conduit, especially conduit having multiple angled turns.

Currently, once inserted into the conduit, the fish tape is marked for the length of wire needed, then pulled out of the pipe and measured with a measuring tape in order to obtain an accurate length of wire needed. Prior fish tapes are not equipped with any form of imprinted measurements in order to obtain the adequate amount of wire needed in less time. Accordingly, there exists today a need for a fish tape and measure that can inform the electrician how much wire is needed and which does not increase the labor that is required to accomplish the task of pulling wire through a conduit.

Therefore, there exists a long felt need in the art for a fish tape measurement device that provides users with electrician fish tape with unit mark measurements along its length. There is also a long felt need in the art for a fish tape measurement device that prevents electricians from wasting cable and wire, ensuring he or she can make precise measurements and cuts for their materials. Further, there is a long felt need in the art for a fish tape measurement device that reduces wire waste and save extensive time and effort on a jobsite. Moreover, there is a long felt need in the art for a device that offers a comprehensive tool for electricians that can be used in almost any situation. Further, there is a long felt need in the art for a fish tape measurement device that looks like a spool of wire with measuring units marked throughout. Finally, there is a long felt need in the art for a fish tape measurement device that can wind in and out from approximately 100-200 feet.

The subject matter disclosed and claimed herein, in one embodiment thereof, comprises a fish tape measurement device. The device is an electrical fish tape tool with unit markings or measurements along its length. The fish tape measurement device comprises a body component that encases a spool of wire. The wire on the spool is a narrow, flat wire, round, or braided, which comprises a plurality of measuring units marked throughout. The wire on the spool can wind in and out from approximately 100 to 200 feet. Thus, the markings will provide electricians with an exact length measurement in order to prevent cable and wire waste when working on a jobsite.

In this manner, the fish tape measurement device of the present invention accomplishes all of the forgoing objectives and provides users with a device that reduces wire waste and saves extensive time and effort on a jobsite. The device is fish tape with measuring units marked throughout. The device provides electricians with an exact length measurement.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a fish tape measurement device. The device is an electrical fish tape tool with unit markings or measurements along its length. The fish tape measurement device comprises a body component that encases a spool of wire or fish tape. The wire on the spool is a narrow, flat wire which comprises a plurality of measuring units marked throughout. The wire on the spool can wind in and out from approximately 100 to 200 feet. Thus, the markings will provide electricians with an exact length measurement in order to prevent cable and wire waste when working on a jobsite.

In one embodiment, the fish tape measurement device discloses an electrical fish tape tool that can determine the length of wire that is required inside a conduit. Further, the fish tape measurement device assists electricians or similar professionals in routing electrical wire through conduit, cavities, or other openings. Briefly, the fish tape measurement device that is constructed in accordance with the principles of the present invention includes a predetermined length of fish tape (i.e., wire) and a body component that encases a center disposed spool that is adapted for both coiling and pulling of the fish tape/wire. A plurality of markings on the fish tape indicate the longitudinal length thereof.

In one embodiment, the fish tape measurement device comprises a body component that encases a spool that is used to wind up (i.e., to spool) a length of fish tape or wire. In use, the body component is grasped and pulled to pull the fish tape through a conduit. As shown, the fish tape has been pushed into the conduit until an end of the fish tape reaches a far end of the conduit. Further, the body component encloses the spool for storing the fish tape. The body component is beneficially fabricated from a durable plastic. The spool rotates within the body component and the body component comprises an opening for expelling the fish tape from the spool. A length of fish tape, preferably made from spring steel or a similar material, is wound (coiled) around and connected at one end to the spool. The other end of the fish tape extends from the opening. The fish tape can be unwound and re-wound through the opening from and onto the spool.

In one embodiment, the body component comprises a handle. The handle is beneficially integrally molded with the body component. The handle provides gripping surfaces that enable easy handling of the body component and the spool.

In one embodiment, the fish tape wound around the spool of the body component is available in multiple lengths, that include 50 feet, 100 feet, 200 feet, 250 feet, and 500 feet, etc. The fish tape can also be of any preferred length as is desired. The fish tape is typically a wire and made of any preferred material but it is generally made of tempered metals, such as spring steel, iron, aluminum, or other suitable materials, such as nylon and has a width of approximately one-eight of an inch and a thickness of approximately 0.060 inches.

In one embodiment, the fish tape comprises a plurality of measuring units marked throughout. The measuring units can be any suitable measurement increment as is known in the art. Thus, a user can read the length of the conduit by looking at a measuring unit that corresponds to where the fish tape first enters the conduit. The plurality of measuring units indicate the length (i.e., the amount) of the fish tape that is in the conduit. The plurality of measuring units are preferably in feet, but they could be in inches or yards, or metric, as desired. The entire length of the fish tape includes additional markings (not shown) that progressively increase in magnitude. The plurality of measuring units may be inscribed, painted, etched, or otherwise attached to the fish tape, as desired.

In one embodiment, the plurality of measuring units comprise raised protrusions which provide an encoded indication of the length of the fish tape. This may be continued as desired or other encodation schemes may be employed. The raised protrusions provide a way in which the length can be determined by tactile means, that is, feel without having to look at the fish tape. This is useful if it is dark or if direct viewing of the fish tape is difficult to accomplish.

In one embodiment, one end of the fish tape is bent to form a hook. At the opposite end of the fish tape there is a flat end. The plurality of measuring units begin where the hook ends. In another embodiment, the plurality of measuring units start at the beginning of the hook and including the length of the hook. Typically, the measuring units start at one (1) inch, but can be one (1) foot increments instead. Each measuring unit is made at exactly every inch and/or foot and is continued throughout the length of the fish tape. The measuring units on the fish tape continue each inch between every foot. Each measuring unit is also made with not only a slash or dot, but also a number and in. for inches or ft. for foot or feet. The measuring units on the fish tape facilitate the process of measuring the desired amount of wire.

In yet another embodiment, the fish tape measurement device comprises a plurality of indicia.

In yet another embodiment, a method of ensuring that electricians can make precise measurements and cuts for their materials is disclosed. The method includes the steps of providing a fish tape measurement device comprising a body component that is configured in a spool of wire, with a plurality of measuring units marked throughout. The method also comprises unspooling the wire with the plurality of measuring units marked throughout. Further, the method comprises inserting the wire into a conduit and using the measuring units to determine how much wire to cut. Finally, the method comprises cutting the appropriate amount of wire based on the measurement units.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the fish tape measurement device of the present invention showing the device in accordance with the disclosed architecture;

FIG. 2 illustrates a perspective view of one embodiment of the fish tape measurement device of the present invention showing the measurement units marked on the wire in accordance with the disclosed architecture;

FIG. 3 illustrates a perspective view of one embodiment of the fish tape measurement device of the present invention showing the device in use in accordance with the disclosed architecture; and

FIG. 4 illustrates a flowchart showing the method of ensuring that electricians can make precise measurements and cuts for their materials in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a fish tape measurement device that provides users with electrician fish tape with unit mark measurements along its length. There is also a long felt need in the art for a fish tape measurement device that prevents electricians from wasting cable and wire, ensuring he or she can make precise measurements and cuts for their materials. Further, there is a long felt need in the art for a fish tape measurement device that reduces wire waste and save extensive time and effort on a jobsite. Moreover, there is a long felt need in the art for a device that offers a comprehensive tool for electricians that can be used in almost any situation. Further, there is a long felt need in the art for a fish tape measurement device that looks like a spool of wire with measuring units marked throughout. Finally, there is a long felt need in the art for a fish tape measurement device that can wind in and out from approximately 100-200 feet.

The present invention, in one exemplary embodiment, is a novel fish tape measurement device. The device is an electrical fish tape tool with unit markings or measurements along its length. The fish tape measurement device comprises a body component that encases a spool of wire. The wire on the spool is a narrow, flat wire which comprises a plurality of measuring units marked throughout. The wire on the spool can wind in and out from approximately 100 to 200 feet. Thus, the markings will provide electricians with an exact length measurement in order to prevent cable and wire waste when working on a jobsite. The present invention also includes a novel method of ensuring that electricians can make precise measurements and cuts for their materials. The method includes the steps of providing a fish tape measurement device comprising a body component that encases a spool of wire, with a plurality of measuring units marked throughout. The method also comprises unspooling the wire with the plurality of measuring units marked throughout. Further, the method comprises inserting the wire into a conduit and using the measuring units to determine how much wire to cut. Finally, the method comprises cutting the appropriate amount of wire based on the measurement units.

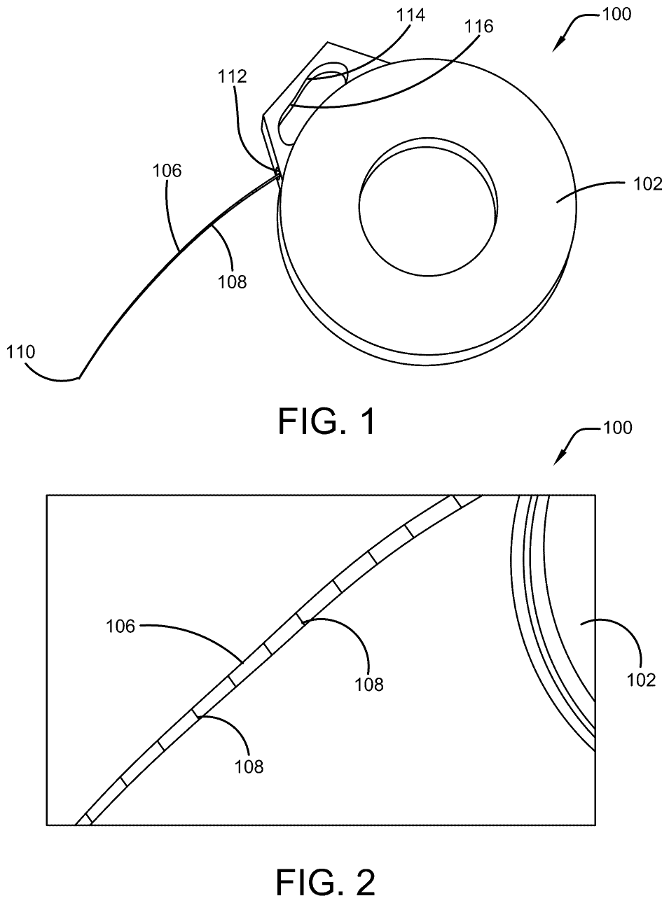

Referring initially to the drawings, FIG. 1 illustrates a perspective view of one embodiment of the fish tape measurement device 100 of the present invention. In the present embodiment, the fish tape measurement device 100 is an improved fish tape measurement device 100 that provides a user with an electrical fish tape tool with measurement markings 108 along its length. Specifically, the fish tape measurement device 100 comprises a body component 102 that encases a spool 104 of fish tape 106. The fish tape 106 is typically a narrow, flat wire which comprises a plurality of measuring units 108 marked throughout. The fish tape 106 on the spool 104 can wind in and out from approximately 100 to 200 feet. Thus, the measuring units 108 will provide electricians with an exact length measurement in order to prevent cable and wire waste when working on a jobsite.

Generally, the fish tape measurement device 100 discloses an electrical fish tape tool that can determine the length of wire that is required inside a conduit. Further, the fish tape measurement device 100 assists electricians or similar professionals in routing electrical wire through conduit, cavities, or other openings. Briefly, the fish tape measurement device 100 that is constructed in accordance with the principles of the present invention includes a predetermined length of fish tape 106 (i.e., wire) and a body component 102 that encases a center disposed spool 104 that is adapted for both coiling and pulling of the fish tape/wire 106. A plurality of markings 108 on the fish tape 106 indicate the longitudinal length thereof.

Further, the fish tape measurement device 100 comprises a body component 102 that encases a spool 104 that is used to wind up (i.e., to spool) a length of fish tape 106 or wire. In use, the body component 102 is grasped and pulled to pull the fish tape 106 through a conduit (not shown). As shown, the fish tape 106 has been pushed into the conduit until an end 110 of the fish tape 106 reaches a far end of the conduit.

Additionally, the body component 102 encloses the spool 104 for storing the fish tape 106. The body component 102 is beneficially fabricated from a durable plastic or other suitable material as is known in the art. The spool 104 rotates within the body component 102 and the body component 102 comprises an opening 112 for expelling the fish tape 106 from the spool 104. The opening 112 can by any suitable shape and size as is known in the art, as long as the opening 112 is sized to expel and/or retract the fish tape 106. Further, a length of fish tape 106, preferably made from spring steel or a similar material, is wound (coiled) around and connected at one end to the spool 104. The other end 110 of the fish tape 106 extends from the opening 112. The fish tape 106 can be unwound and re-wound through the opening 112 from and onto the spool 104, as needed.

Typically, the body component 102 comprises a handle 114 of any suitable shape and size as is known in the art. The handle 114 is beneficially integrally molded with the body component 102 and typically manufactured of the same material as the body component 102. The handle 114 provides gripping surfaces 116 that enable easy handling of the body component 102 and the spool 104.

As shown in FIG. 2, the fish tape 106 wound around the spool 104 of the body component 102 is available in multiple lengths, that include 50 feet, 100 feet, 200 feet, 250 feet, and 500 feet, etc. The fish tape 106 can also be of any preferred length as is desired. The fish tape 106 is typically a wire and made of any preferred material but it is generally made of tempered metals, such as spring steel, iron, aluminum, or other suitable materials, such as nylon and has a width of approximately one-eight of an inch and a thickness of approximately 0.060 inches, but can be any suitable shape and size as is known in the art.

Further, the fish tape 106 comprises a plurality of measuring units 108 marked throughout. The measuring units 108 can be any suitable measurement increment as is known in the art. Thus, a user can read the length of the conduit by looking at a measuring unit 108 that corresponds to where the fish tape 106 first enters the conduit. The plurality of measuring units 108 indicate the length (i.e., the amount) of the fish tape 106 that is in the conduit. The plurality of measuring units 108 are preferably in feet, but they could be in inches or yards, or metric, as desired. The entire length of the fish tape 106 includes additional markings (not shown) that progressively increase in magnitude. The plurality of measuring units 108 may be inscribed, painted, etched, or otherwise attached to the fish tape 106, as desired.

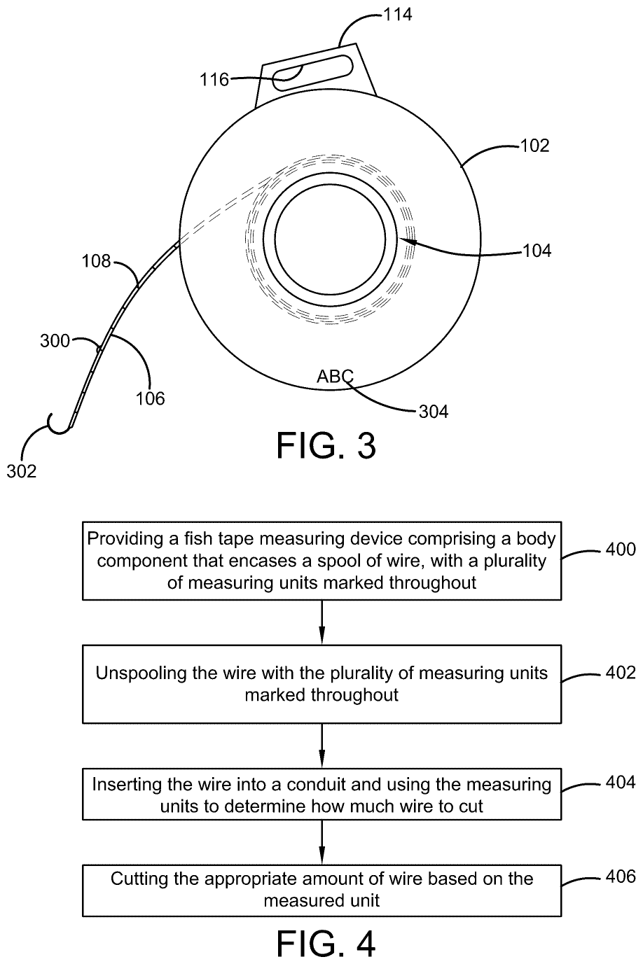

As shown in FIG. 3, in one embodiment, the plurality of measuring units 108 comprise raised protrusions 300 which provide an encoded indication of the length of the fish tape 106. This may be continued as desired or other encodation schemes may be employed. The raised protrusions 300 provide a way in which the length can be determined by tactile means, that is, feel without having to look at the fish tape 106. This is useful if it is dark or if direct viewing of the fish tape 106 is difficult to accomplish.

In another embodiment, one end 110 of the fish tape 106 is bent to form a hook 302. At the opposite end of the fish tape 106 there is a flat end. The plurality of measuring units 108 begin where the hook 302 ends. In another embodiment, the plurality of measuring units 108 start at the beginning of the hook 302 and including the length of the hook 302. Typically, the measuring units 108 start at one (1) inch, but can be one (1) foot increments instead. Each measuring unit 108 is made at exactly every inch and/or foot and is continued throughout the length of the fish tape 106. The measuring units 108 on the fish tape 106 continue each inch between every foot. Each measuring unit 108 is also made with not only a slash or dot, but also a number and in. for inches or ft. for foot or feet. The measuring units 108 on the fish tape 106 facilitate the process of measuring the desired amount of wire.

In yet another embodiment, the fish tape measurement device 100 comprises a plurality of indicia 304. The body component 102 of the device 100 may include advertising, a trademark, or other letters, designs, or characters, printed, painted, stamped, or integrated into the body component 102, or any other indicia 304 as is known in the art. Specifically, any suitable indicia 304 as is known in the art can be included, such as but not limited to, patterns, logos, emblems, images, symbols, designs, letters, words, characters, animals, advertisements, brands, etc., that may or may not be fish tape, electrician, or brand related.

FIG. 4 illustrates a flowchart of the method of ensuring that electricians can make precise measurements and cuts for their materials. The method includes the steps of at 400, providing a fish tape measurement device comprising a body component that encases a spool of wire, with a plurality of measuring units marked throughout. The method also comprises at 402, unspooling the wire with the plurality of measuring units marked throughout. Further, the method comprises at 404, inserting the wire into a conduit and using the measuring units to determine how much wire to cut. Finally, the method comprises at 406, cutting the appropriate amount of wire based on the measurement units.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “fish tape measurement device”, “fish tape device”, “measurement device”, and “device” are interchangeable and refer to the fish tape measurement device 100 of the present invention.

Notwithstanding the forgoing, the fish tape measurement device 100 of the present invention can be of any suitable size and configuration as is known in the art without affecting the overall concept of the invention, provided that it accomplishes the above stated objectives. One of ordinary skill in the art will appreciate that the fish tape measurement device 100 as shown in FIGS. 1-4 is for illustrative purposes only, and that many other sizes and shapes of the fish tape measurement device 100 are well within the scope of the present disclosure. Although the dimensions of the fish tape measurement device 100 are important design parameters for user convenience, the fish tape measurement device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A fish tape measurement device that provides a user with an electrical fish tape tool with measurement markings along its length, the fish tape measurement device comprising:
a body component;
a spool of fish tape; and
a plurality of measuring units;
wherein the body component encases the spool of fish tape;
wherein the fish tape comprises the plurality of measuring units marked throughout its length; and
further wherein the plurality of measuring units provide electricians with an exact length measurement in order to prevent cable and wire waste when working on a jobsite.

2. The fish tape measurement device of claim 1, wherein the fish tape measurement device determines a length of wire that is required inside a conduit.

3. The fish tape measurement device of claim 2, wherein the body component encases the spool of fish tape for storing the fish tape.

4. The fish tape measurement device of claim 3, wherein the spool of fish tape rotates within the body component.

5. The fish tape measurement device of claim 4, wherein the body component comprises an opening for expelling the fish tape from the spool.

6. The fish tape measurement device of claim 5, wherein a length of the fish tape is wound around and connected at one end to the spool, the other end of the fish tape extends from the opening, allowing the fish tape to be unwound and re-wound through the opening from and onto the spool.

7. The fish tape measurement device of claim 6, wherein the body component comprises a handle integrally molded with the body component and having gripping surfaces for easy handling of the body component.

8. The fish tape measurement device of claim 7, wherein the fish tape wound around the spool of the body component is available in multiple lengths.

9. The fish tape measurement device of claim 8, wherein the fish tape is manufactured of spring steel.

10. The fish tape measurement device of claim 9, wherein the plurality of measuring units indicate a length of the fish tape that is in a conduit.

11. The fish tape measurement device of claim 10, wherein the plurality of measuring units can be in feet, inches, yards, or metric measurements.

12. The fish tape measurement device of claim 11, wherein the plurality of measuring units are inscribed, painted, etched, or stamped to the fish tape.

13. A fish tape measurement device that provides a user with an electrical fish tape tool with measurement markings along its length, the fish tape measurement device comprising:
a body component comprising a handle integrally molded with the body component;
a spool of fish tape; and
a plurality of measuring units which can be in feet, inches, yards, or metric measurements;
wherein the body component encases the spool of fish tape;
wherein the spool of fish tape rotates within the body component;
wherein the body component comprises an opening for expelling the fish tape from the spool;
wherein a length of the fish tape is wound around and connected at one end to the spool, the other end of the fish tape extends from the opening, allowing the fish tape to be unwound and re-wound through the opening from and onto the spool;
wherein the fish tape comprises the plurality of measuring units marked throughout its length;
wherein the plurality of measuring units are inscribed, painted, etched, or stamped to the fish tape;
wherein a length of wire that is required inside a conduit is determined; and
further wherein the plurality of measuring units provide electricians with an exact length measurement in order to prevent cable and wire waste when working on a jobsite.

14. The fish tape measurement device of claim 13, wherein the plurality of measuring units comprise raised protrusions which provide an encoded indication of a length of the fish tape.

15. The fish tape measurement device of claim 13, wherein one end of the fish tape is bent to form a hook.

16. The fish tape measurement device of claim 15, wherein the plurality of measuring units begin where the hook ends.

17. The fish tape measurement device of claim 15, wherein the plurality of measuring units start at a beginning of the hook and include a length of the hook.

18. The fish tape measurement device of claim 13, wherein each of the plurality of measuring units are made with a slash or dot, but also a number and in. for inches or ft. for foot or feet.

19. The fish tape measurement device of claim 13 further comprising a plurality of indicia.

20. A method of ensuring that electricians can make precise measurements and cuts for their materials, the method comprising the following steps:
providing a fish tape measurement device comprising a body component that encases a spool of wire, with a plurality of measuring units marked throughout;
unspooling the wire with the plurality of measuring units marked throughout;
inserting the wire into a conduit and using the measuring units to determine how much wire to cut; and
cutting the appropriate amount of wire based on the measurement units.
